(19) United States
(12) Patent Application Publication
(10) Pub. No.: US 2026/0139780 A1
(43) Pub. Date: May 21, 2026

(54) CONNECTOR STRUCTURE FOR WATER-COOLING DEVICE

(71) Applicant: BRIMO TECHNOLOGY INC., Taipei (TW)

(72) Inventor: Chi-Hsien HUANG, Taipei (TW)

(21) Appl. No.: 18/951,137

(22) Filed: Nov. 18, 2024

(51) Int. Cl. F16L 37/14

(52) U.S. Cl. CPC F16L 37/14

(57) ABSTRACT

A connector structure for water-cooling device comprises an adapter with two connecting portions, a connector with a docking space on the inside of a connector body for one connecting portion of the adapter to insert therein and a positioning ring with a hollow groove on the outside thereof, and a coupling member including a wrap mounted on the positioning ring and forming an elastic clamp and provided with an abutting portion passing through the hollow groove and abutting against the outside of the connecting portion to form a fixed state and a release button installed at the top opening of the wrap and pushed upward by the elastic clamping force of the wrap. The release button moves downward to push open the wrap and make the abutting portion disengage from the connecting portion, so that the adapter and the connector are in a detachable state.

### BACKGROUND OF THE INVENTION

### 1. Field of the Invention

The present invention is a connector structure for water-cooling device, particularly when an adapter and a connector need to be assembled, the connecting portion of the adapter can be pushed into the docking space of the connector through the coupling member outside the connector to abut against the abutting portion of the wrap, and after the wrap is pushed open outward, the abutting portion slides along the outside of the connecting portion and forms an abutting and fixed state, thereby forming a quick assembly and good sealing structure between the adapter and the connector; when the adapter and the connector need to be disassembled, the user can press the release button at the top of the wrap downward to push open the first flap and the second flap of the wrap and allow the two abutting portions to pass over and detach from the stopper on the outer wall of the connecting portion, so that the adapter and the connector can be reversely disengaged. This has the advantages of fewer components and simpler assembly.

### 2. Description of the Related Art

With the rapid development of electronic technology and network technology, both personal computers and computer servers have become an indispensable part of people's daily lives. At the same time, with the rise of the e-sports industry, the performance of computers used in e-sports must also meet the requirements of online games where every second counts. The improvement of computer performance is also accompanied by an increase in the heat generated by the computer's internal components, which has a serious impact on the computer's performance and service life. Therefore, a good heat dissipation device must be provided to cool the computer components to ensure smooth computer operation.

Furthermore, the computer heat dissipation methods can be roughly divided into air-cooling and water-cooling systems. The method of air-cooling system is to use multiple fans to draw cold air from the outside of the computer into the computer, and dissipates heat from heat-prone components (such as the central processing unit, graphics processing unit, access device, interface card or power component) through the design of the air flow channel. The hot air with increased temperature is then discharged to the outside of the computer through the fans to complete the air-cooling heat dissipation effect. The air-cooling system has the advantages of simple structure and low cost, but its disadvantages are that its heat dissipation effect is relatively general and it is easy to accumulate a lot of dust inside the computer. In contrast, the water-cooling system has the advantage of good heat dissipation effect. The method is to set a cold plate on the heat generating element, and the cold plate is provided with heat dissipation fins and water-cooling liquid flow channels. The water coolant in the cold plate absorbs the heat of the heating generating element, and the water pump connected to the cold plate generates the water-cooling liquid flow and transports it to a water pipe, and then the water pipe transports the hot water coolant to a water-cooling radiator with heat sink and fan to cool the water coolant by air cooling. The cooled water coolant is then transported through another water pipe and returned to the cold plate to complete the water-cooling cycle and heat dissipation.

The above-mentioned water-cooling circulation heat dissipation system has the advantage of high-efficiency heat dissipation, and it is therefore widely used in the e-sports industry or other industries requiring high-performance computers or servers. However, the water-cooling circulation heat dissipation system needs to use an adapter and its matching connector at the turning point of the water-cooling pipes to achieve the purpose of redirecting the water transport path. When the water cooling pipes, the adapter and the connector are connected, the connector body must not be deformed in size, and the connector structure must be able to maintain good sealing and quick installation/disassembly, which has become a topic that the industry is eager to work hard on.

### SUMMARY OF THE INVENTION

Therefore, in view of the above problems and deficiencies, the inventor collected relevant information and, after multiple evaluations and considerations, designed this connector structure for water-cooling device.

The main object of the present invention is to provide a connector structure for water-cooling device, which comprises an adapter comprising at least two connecting portions; a connector comprising a connector body, a docking space formed inside the connector body for one connecting portion of the adapter to pass through, a positioning ring formed outside the connector body and at least one hollow groove formed on the positioning ring, and a coupling member comprising a wrap and a release button. The wrap is mounted on the positioning ring to form an elastic clamp. The wrap comprises at least one abutting portion formed on an inner wall thereof and passing through the hollow groove and abutting against the outside of the connecting portion in the docking space to form a fixed state. The release button is installed at the top opening of the wrap and is pushed upward by the elastic clamping force of the wrap. The release button is subject to an external force to move downward to push open the wrap and make the abutting portion disengage from the connecting portion in the docking space, so that the adapter and the connector are in a detachable state.

Through the above, when the adapter and the connector need to be assembled, the connecting portion of the adapter can be pushed into the docking space of the connector through the coupling member outside the connector to abut against the abutting portion of the wrap, and after the wrap is pushed open outward, the abutting portion slides along the outside of the connecting portion and forms an abutting and fixed state, thereby forming a quick assembly and a good sealing structure between the adapter and the connector. When the adapter and the connector need to be disassembled, the user can press the release button at the top of the wrap downward to push open the first flap and the second flap of the wrap and allow the two abutting portions to pass over and detach from the stopper on the outer wall of the connecting portion, so that the adapter and connector can be reversely disengaged. This has the advantages of fewer components and simpler assembly.

Another object of the present invention is that the wrap is composed of a first flap and a second flap, two first coupling portions are disposed on the bottom side of the first flap, and a second coupling portion is disposed on the bottom side of the second flap and is inserted between the two first coupling portions. Each of the two first coupling portions and the second coupling portion have an axial hole for a pivot to pass through. One end of the pivot is inserted and fixed in the outer wall surface of the connector body of the connector facing the adapter, and the inner walls of the first flap and the second flap are both protrudingly provided with the abutting portions.

Still another object of the present invention is that the first flap and the second flap are respectively formed with two first limiting portions and two second limiting portions turned inwardly at their top sides, and a first slide groove and a second slide groove are respectively formed inside the two first limiting portions and the two second limiting portions. The first slide groove and the second slide groove are used for positioning two guide plates that converge downward at the bottom side of the release button to form a vertical movement structure of the release button on the wrap.

Still another object of the present invention is that the first flap and the second flap have a positioning groove formed on their exteriors, and the positioning groove is used for a U-shaped elastic member to be combined and positioned.

Still another object of the present invention is that the release button comprises a base portion located at the bottom and a plate-shaped operating portion located at the top. The base portion has two guide plates formed on both sides thereof and a central protrusion located between the two guide plates. Two limiting grooves are formed between the two guide plates and the central protrusion for positioning the two first limiting portions and the two second limiting portions of the wrap. The central protrusion has two stop blocks formed at the bottom side thereof for stopping the two first limiting portions and the two second limiting portions.

### BRIEF DESCRIPTION OF THE DRAWINGS

FIG. 1 is a three-dimensional external view of the connector structure for water-cooling device of the present invention.

FIG. 2 is a three-dimensional external view of the connector structure for water-cooling device of the present invention from another angle.

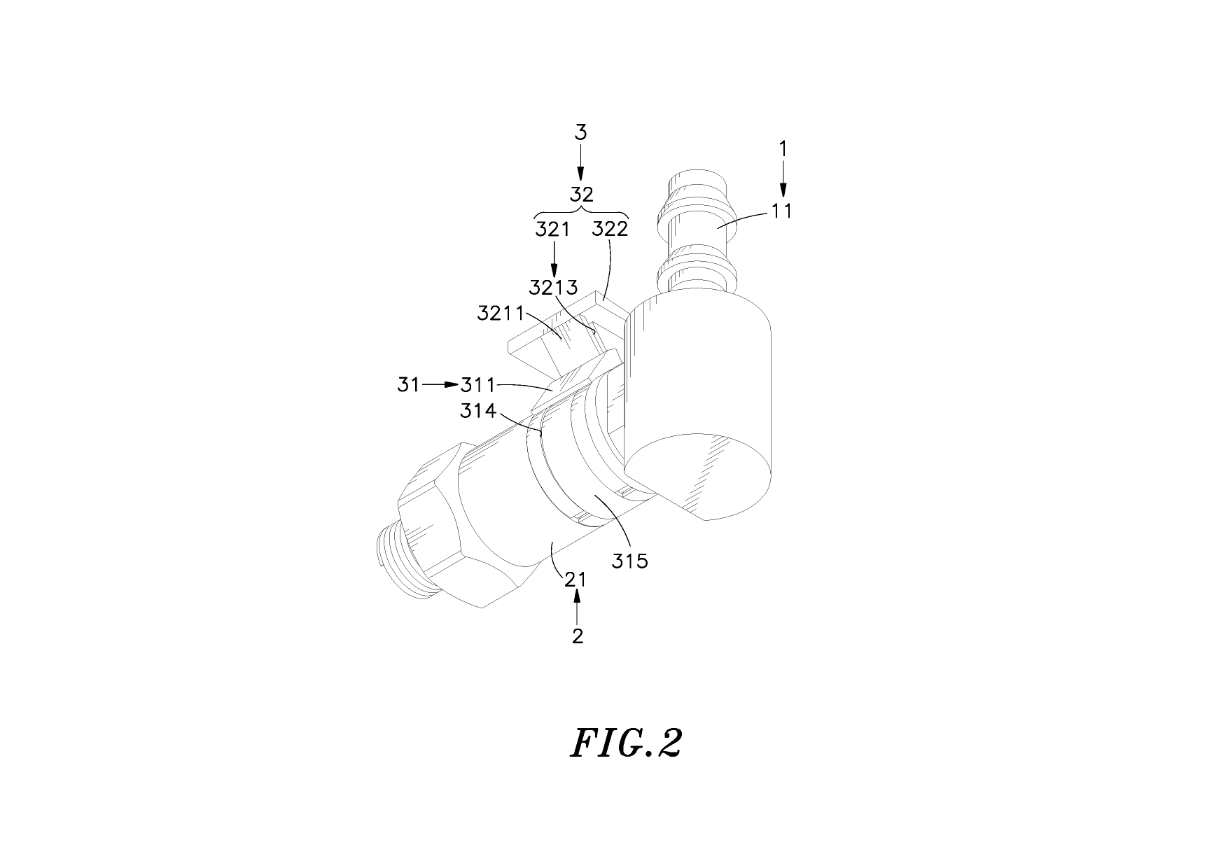

FIG. 3 is a three-dimensional exploded view of the connector structure for water-cooling device of the present invention.

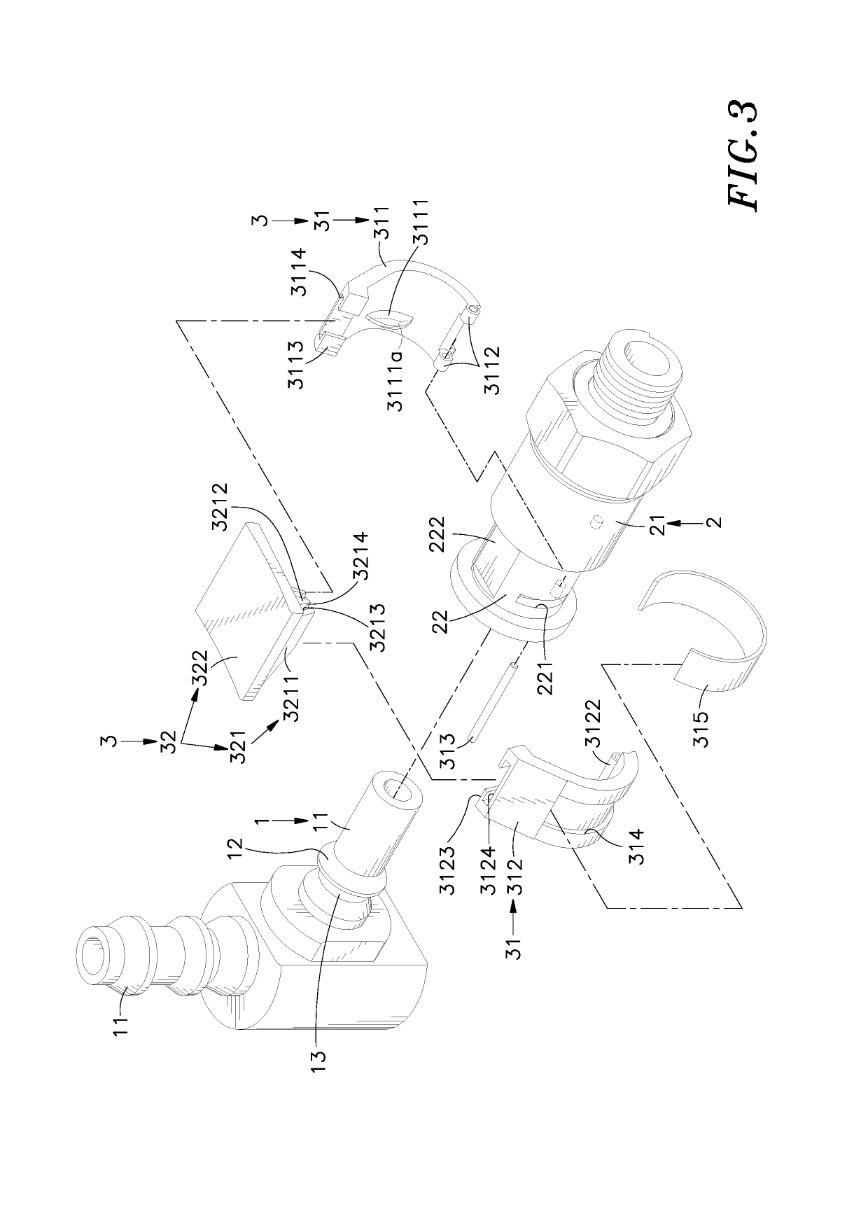

FIG. 4 is a three-dimensional exploded view of the connector structure for water-cooling device of the present invention from another angle.

FIG. 5 is a side cross-sectional view of the connector structure for water-cooling device of the present invention.

FIG. 6 is a front cross-sectional view of the connector structure for water-cooling device of the present invention during installation.

FIG. 7 is a front cross-sectional view of the connector structure for water-cooling device of the present invention when disassembled.

FIG. 8 is a three-dimensional external view of another embodiment of the connector structure for water-cooling device of the present invention.

FIG. 9 is a side cross-sectional view of FIG. 8.

### DETAILED DESCRIPTION OF THE INVENTION

In order to achieve the above-mentioned objects and effect, the technical means and structure adopted by the present invention are described in detail with reference to the preferred embodiments of the present invention, and its features and functions are as follows for a complete understanding.

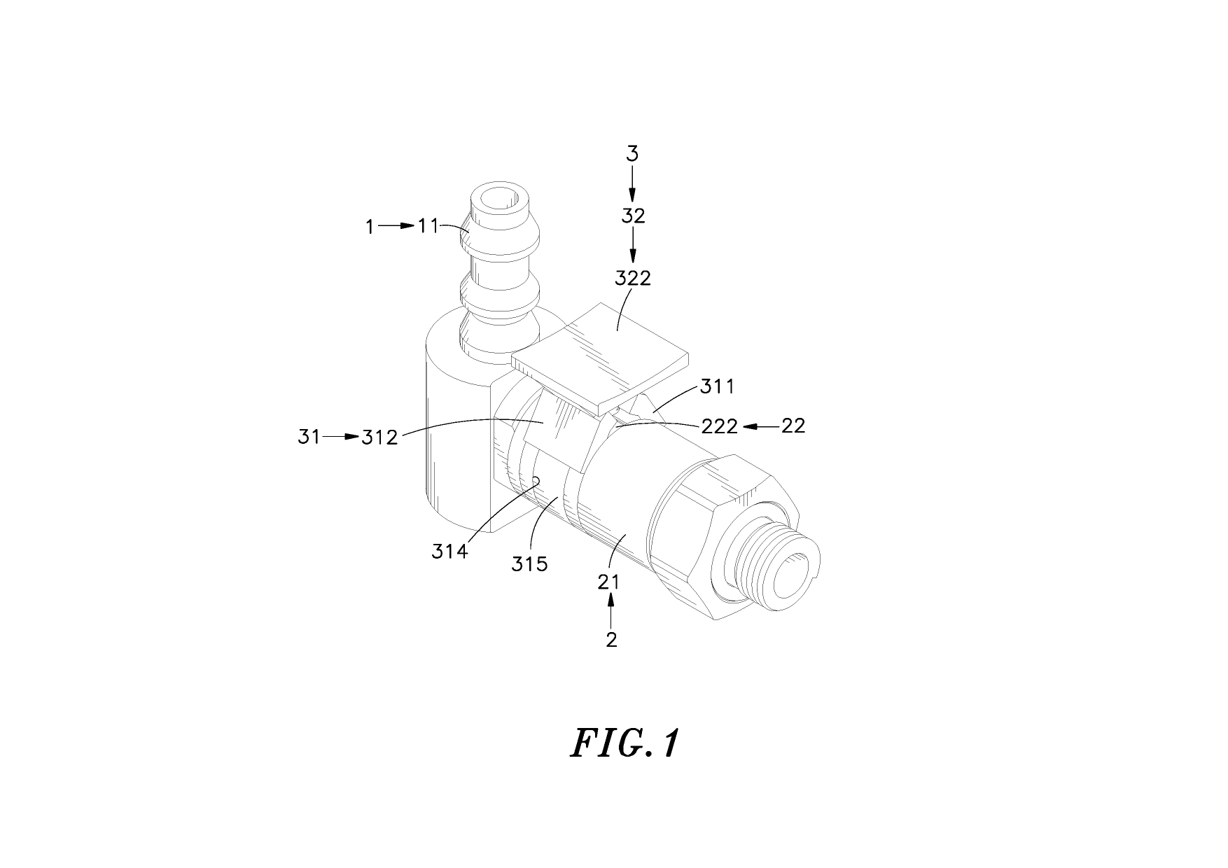

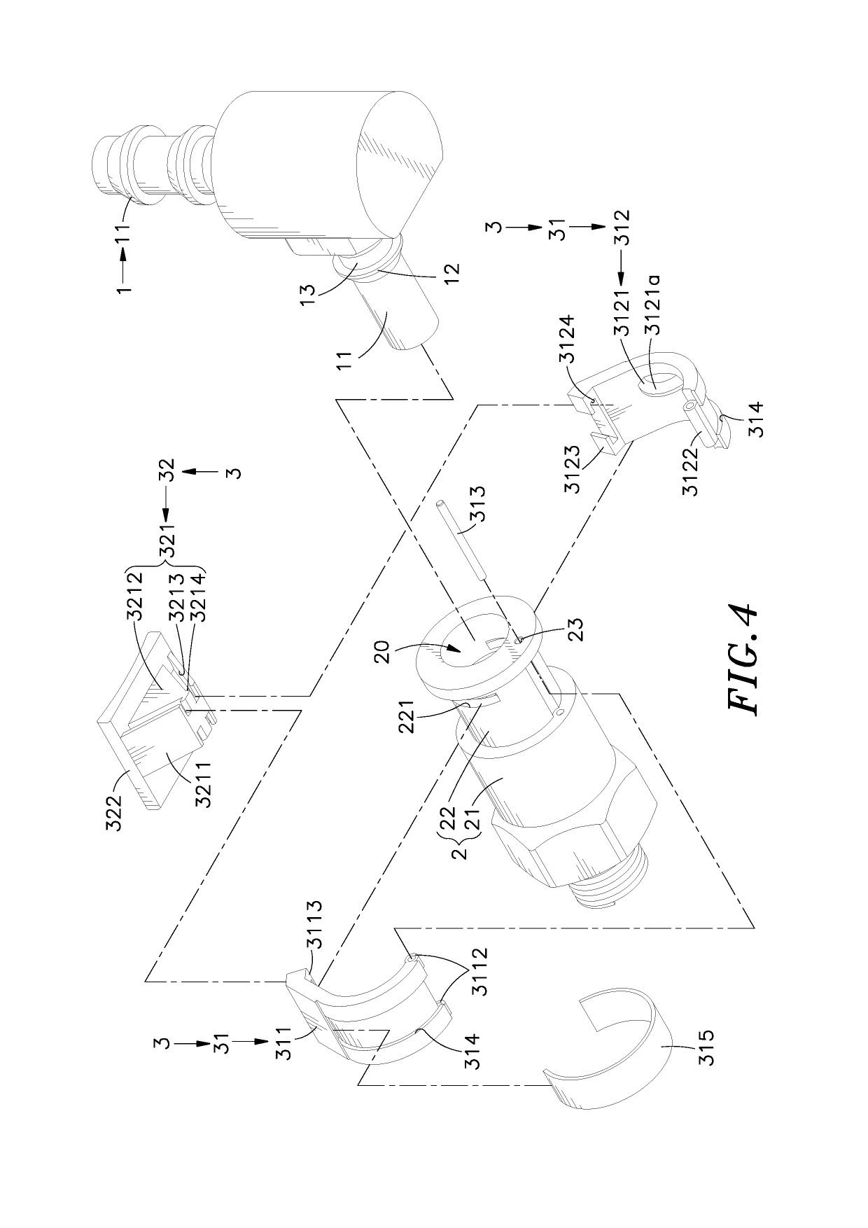

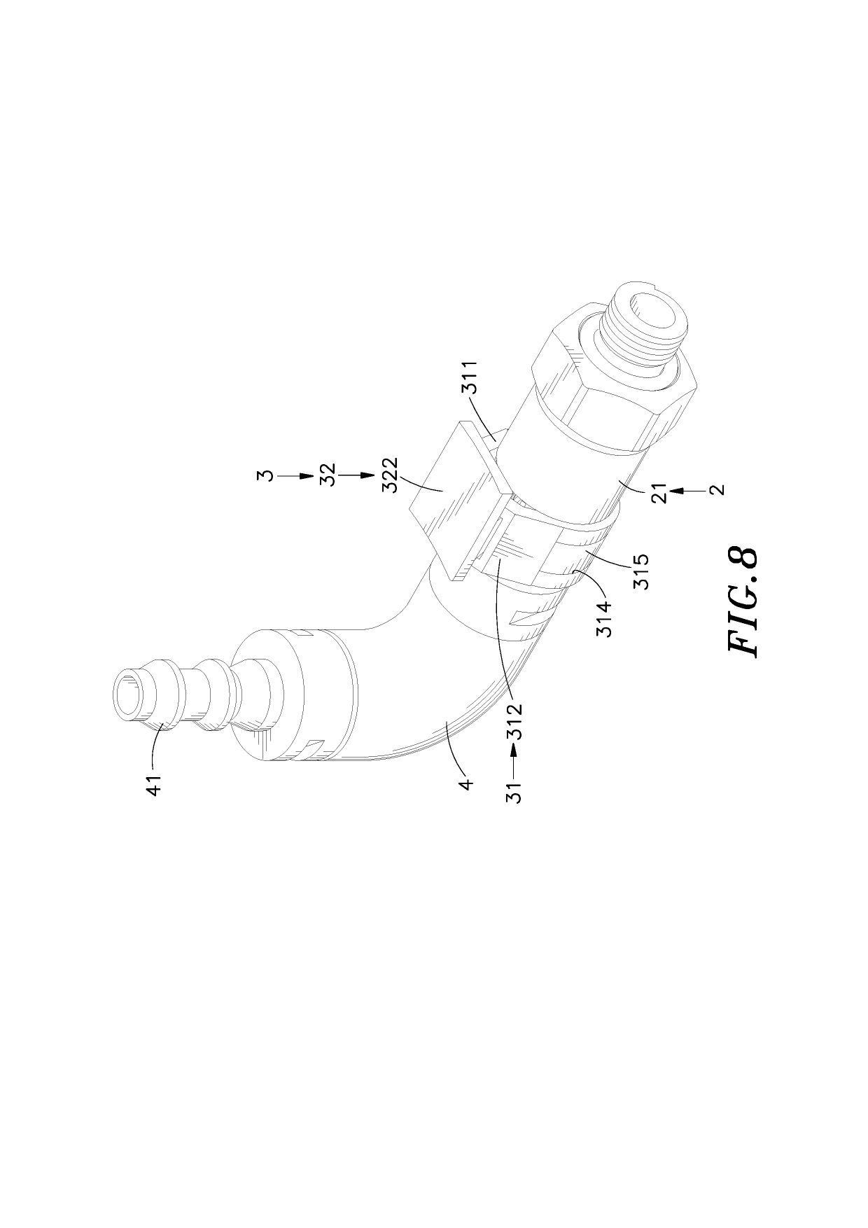

Please refer to FIGS. 1, 4, 8, and 9 which are respectively a three-dimensional external view, a three-dimensional external view from another angle, a three-dimensional exploded view, a three-dimensional exploded view from another angle, a three-dimensional external view of another embodiment, and a side cross-sectional view of FIG. 8 of the connector structure for water-cooling device of the present invention. As can be clearly seen from the figures, the connector structure of the present invention mainly comprises an adapter (1, 4), a connector 2 and a coupling member 3, and its main components and features are described in detail as follows:

The adapter (1, 4) comprises at least two connecting portions (11, 41).

The connector 2 comprises a connector body 21, a docking space 20 formed inside the connector body 21 for the connecting portion (11, 41) of the adapter (1, 4) to pass through, a positioning ring 22 formed outside the connector body 21 and at least one hollow groove 221 formed on the positioning ring 22.

The coupling member 3 comprises a wrap 31 mounted on the positioning ring 22 and forming an elastic clamp, and a release button 32 installed at the top opening of the wrap 31 to be pushed upward by the elastic clamping force. The inner wall of the wrap 31 is provided with at least one abutting portion (3111, 3121) which passes through the hollow groove 221 and abuts against the outside of the connecting portion (11, 41) to form a fixed connection. The release button 32 moves downward to push open the wrap 31 and disengage the abutting portion (3111, 3121) from the connecting portion (11, 41), so that the adapter (1, 4) and the connector 2 are in a detachable state.

The main body of the above-mentioned adapter (1, 4) is in the shape of a cutting cylinder (as shown in FIG. 1) or a tubular body (as shown in FIG. 8), but the main body of the adapter (1, 4) is not limited to the aforementioned shapes. Any geometric shape that can be demolded is within the scope of protection. The two connecting portions (11, 41) of the adapter (1, 4) are perpendicular to each other, one of which is a water inlet pipe and the other is a water outlet pipe, so as to form a water transport path for redirecting. The outer wall of the connecting portion (11, 41) of the adapter (1, 4) is provided with a stopper (12, 42) for the abutting portion (3111, 3121) of the coupling member 3 to pass over, and a positioning portion (13, 43) for the abutting portion (3111, 3121) to be positioned. The stopper (12, 42) forms a stopping structure of the abutting portion (3111, 3121) to prevent the adapter (1, 4) from being separated from the connector 2.

The above-mentioned positioning ring 22 of the connector 2 has a flat stop surface 222 corresponding to the bottom side of the release button 32, and the movable stroke of the release button 32 is determined according to the depth of the stop surface 222 in the positioning ring 22. The docking space 20 of the connector 2 is provided with a core tube 24 and a first spring 25 is sleeved on the outside of the core tube 24. The two ends of the first spring 25 are respectively abutted against and locked on a water guide 26 of the water outlet and the narrow pipe wall. The water guide 26 comprises a locking portion 261 with an external thread and an extension portion 262 extending into the water outlet. The water guide 26 is screwed into the connector 2 to make it easier for the aqueous solution in the core tube 24 to flow to the water outlet, thereby preventing the end of the core tube 24 from seeping into the docking space 20 and causing leakage.

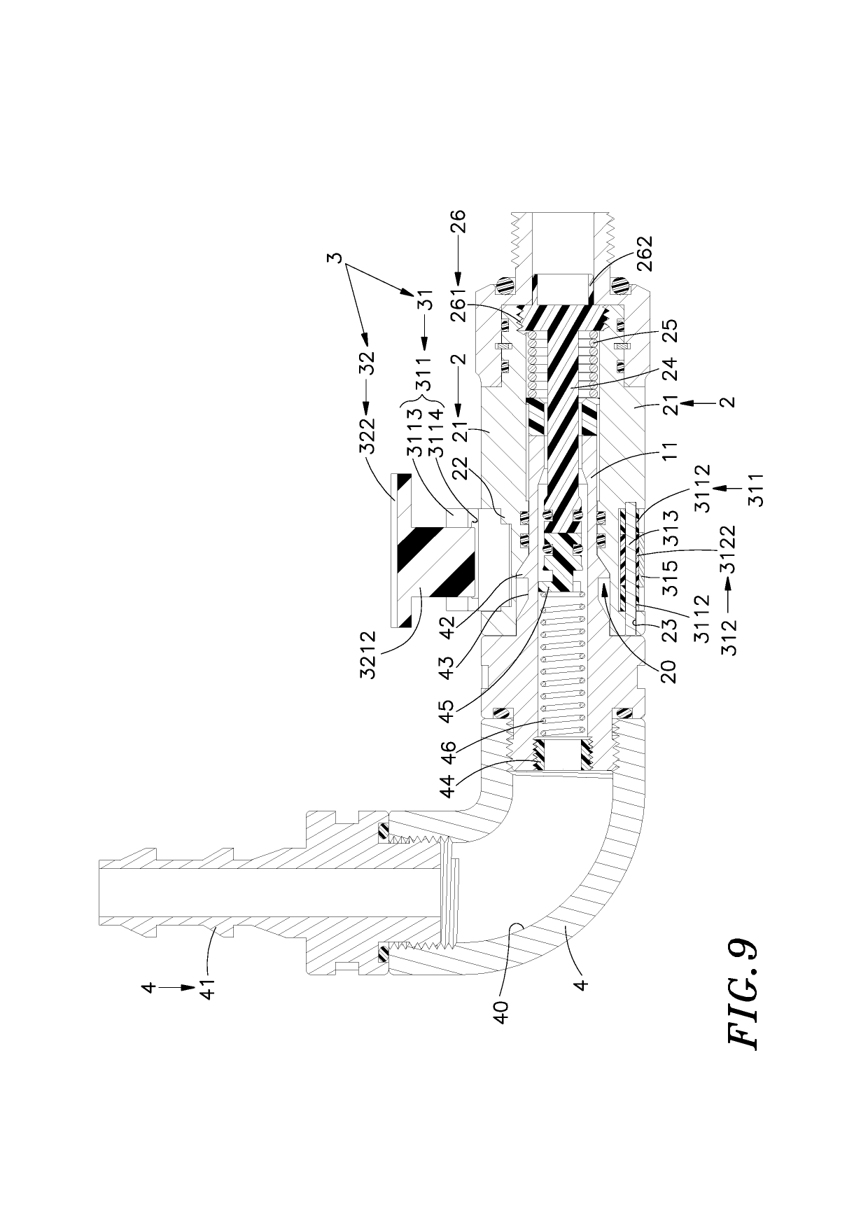

Please refer to FIG. 9, the tubular adapter 4 further comprises an enlarged water diversion channel 40 inside, which helps to guide the aqueous solution to the water outlet of the connecting portion 41 more easily, a first abutment seat 44 and a second abutment seat 45 respectively provided at the horizontal end of the water diversion channel 40 and the water outlet of the connecting portion 41, and a second spring 46 installed between the first abutment seat 44 and the second abutment seat 45. By installing the first abutment seat 44 and the second abutment seat 45, the two ends of the second spring 46 can be more firmly supported, thereby preventing the second spring 46 from erroneously operating during compression and rebound.

The above-mentioned wrap 31 is composed of a first flap 311 and a second flap 312. Two first coupling portions 3112 are provided at the bottom side of the first flap 311 and a second coupling portion 3122 is provided at the bottom side of the second flap 312 and is inserted between the two first coupling portions 3112. Each of the two first coupling portions 3112 and the second coupling portion 3122 have an axial hole (not shown) for a pivot 313 to pass through. One end of the pivot 313 is inserted and fixed in a shaft groove 23 of the outer wall surface of the connector body 21 of the connector 2 facing the adapter (1, 4), and the inner walls of the first flap 311 and the second flap 312 are both protrudingly provided with the abutting portions (3111, 3121). The edges of the abutting portions (3111, 3121) are respectively formed with a beveled guide surface (3111a, 3121a). When assembling the adapter 1 and the connector 2, the beveled guide surface (3111a, 3121a) can make it easier to push open the wrap 31 outward when the connecting portions (11, 41) of the adapter (1, 4) abut against each other, thereby making the assembly of the adapter 1 and the connector 2 smoother.

The above-mentioned first flap 311 and the second flap 312 respectively have two first limiting portions 3113 and two second limiting portions 3123 bent inwardly and formed at their tops, and a first slide groove 3114 and a second slide groove 3124 are respectively formed inside the two first limiting portions 3113 and the two second limiting portions 3123. The first slide groove 3114 and the second slide groove 3124 are provided for positioning two guide plates 3211 which converge downward at the bottom side of the release button 32, so as to form a vertical movement structure of the release button 32 on the wrap 31. The first flap 311 and the second flap 312 have a positioning groove 314 formed on their exteriors, and the positioning groove 314 is provided for a U-shaped elastic member 315 to be combined and positioned. The elastic member 315 can provide a clamping force when the first flap 311 and the second flap 312 are closed and a restoring force after they are pushed open, and a preferred material for the elastic member 315 is a metal spring.

The above-mentioned release button 32 comprises a base portion 321 at the bottom and a plate-shaped operating portion 322 at the top. The base portion 321 has two sides that converge downward to form the two guide plates 3211 and a central protrusion 3212 located between the two guide plates 3211. Two limiting grooves 3213 are respectively formed between the two guide plates 3211 and the central protrusion 3212 for positioning the two first limiting portions 3113 and the two second limiting portions 3123 of the wrap 31. The central protrusion 3212 has two stop blocks 3214 formed at the bottom side thereof for stopping the two first limiting portions 3113 and the two second limiting portions 3123.

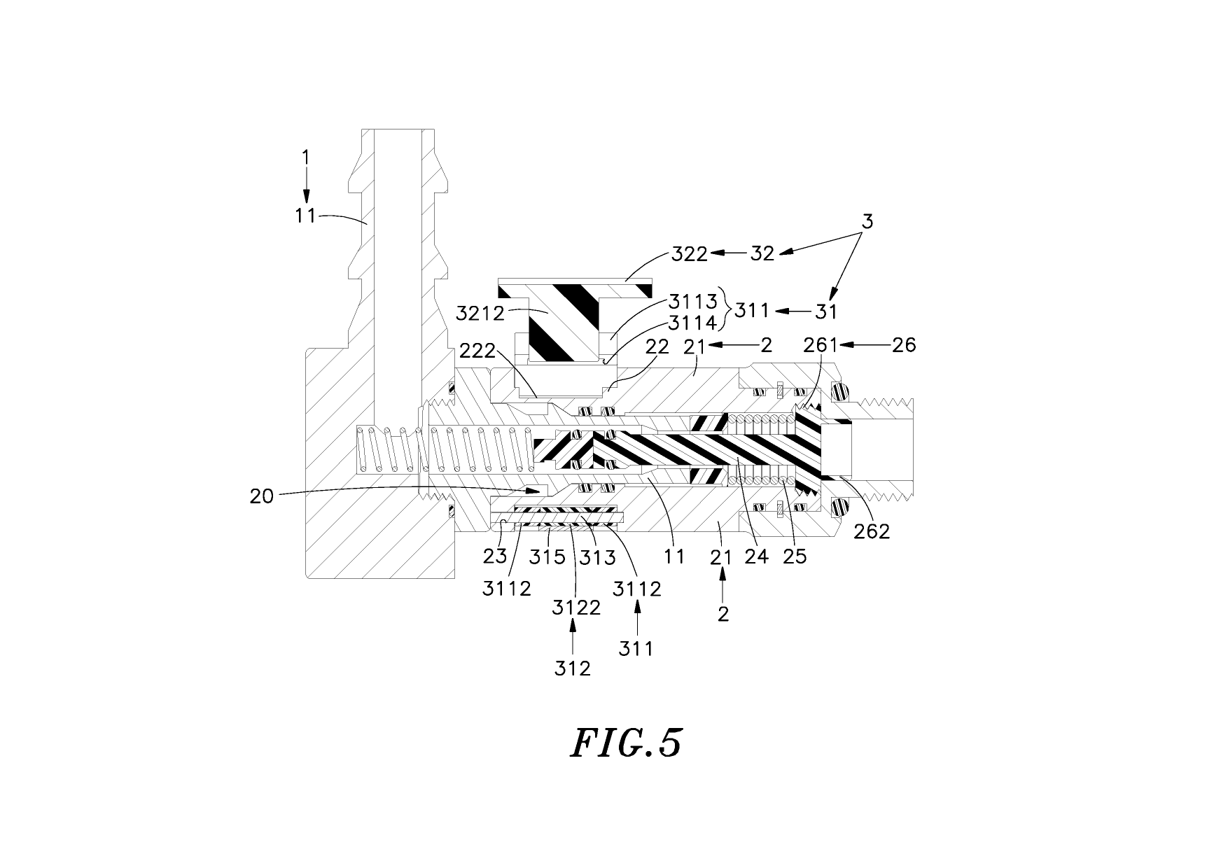

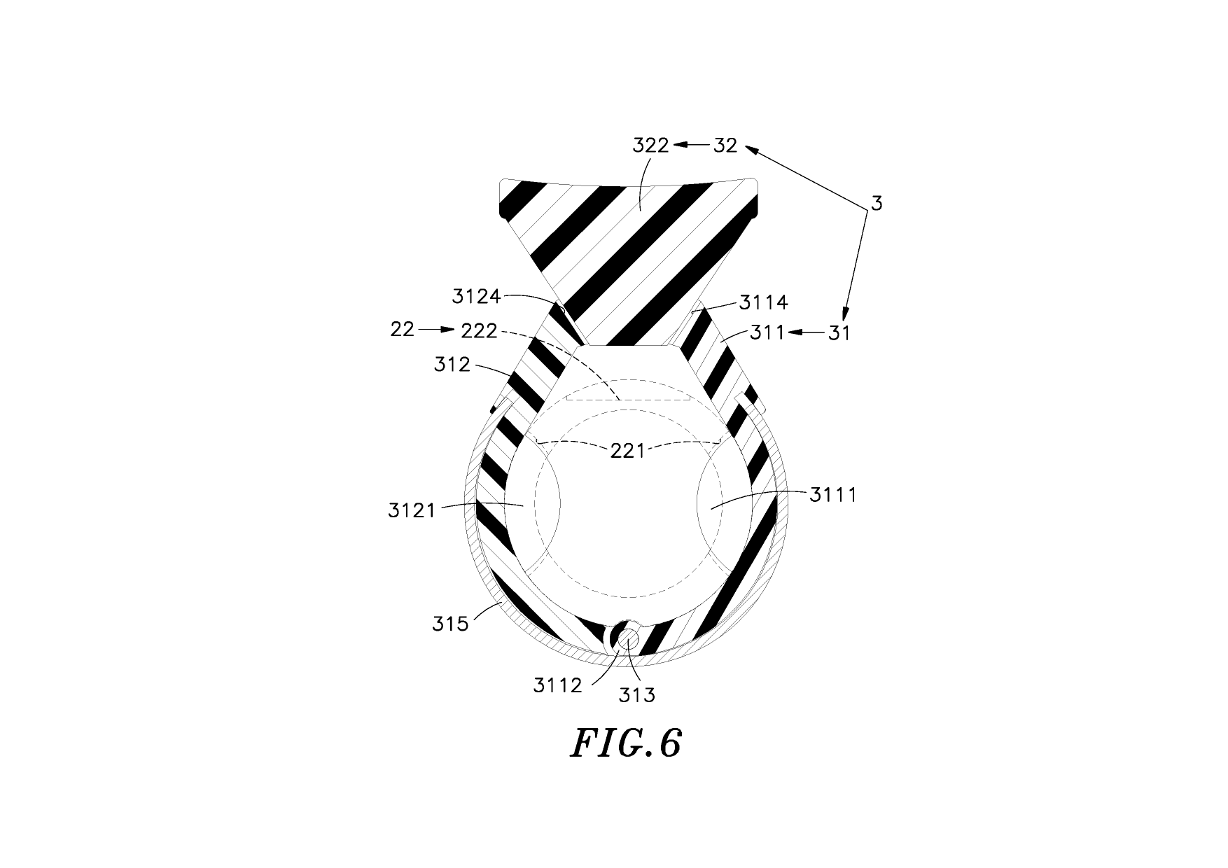

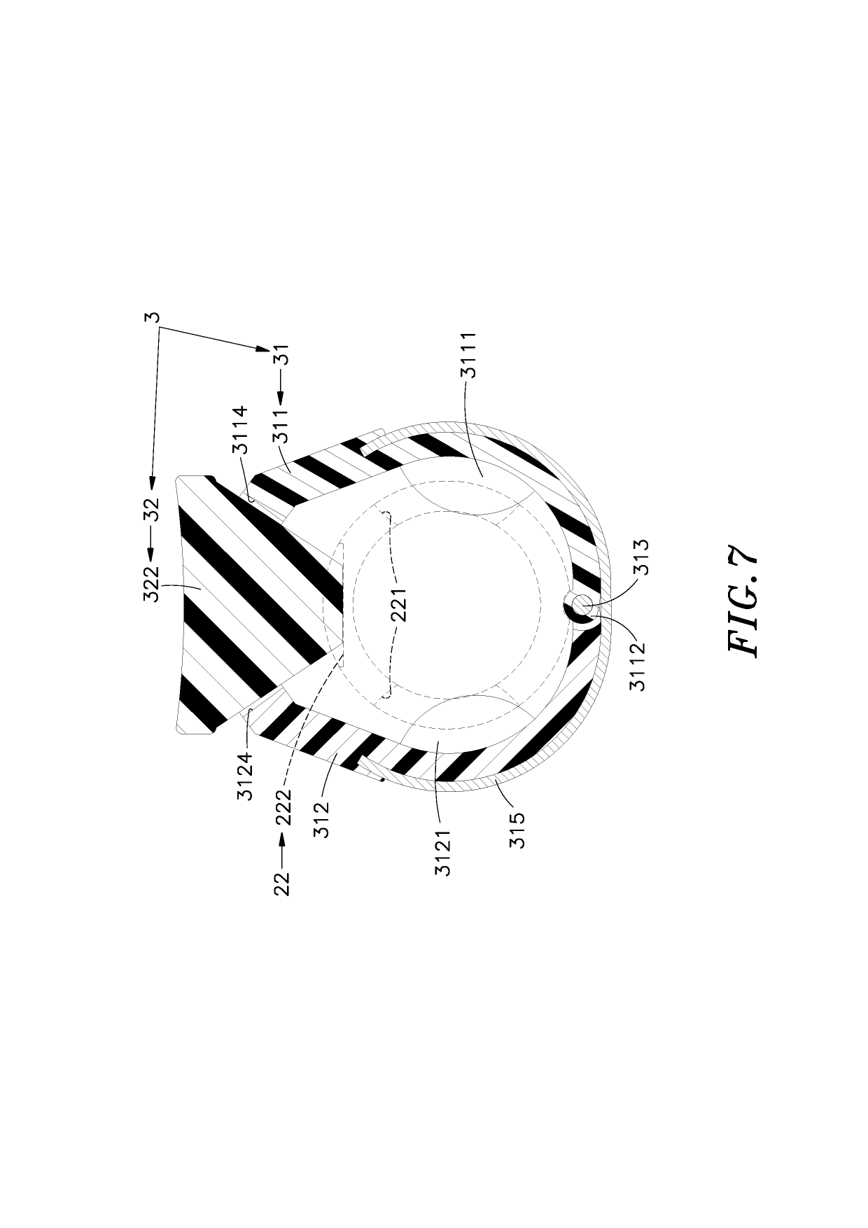

Please refer to FIGS. 5-7, which are respectively a side cross-sectional view of the connector structure for water-cooling device of the present invention, a front cross-sectional view of the connector structure for water-cooling device of the present invention during installation and a front cross-sectional view of the connector structure for water-cooling device of the present invention when disassembled. When assembling the adapter 1 and the connector 2 in actual operation (the operation method of the adapter 4 in another embodiment is the same, so it is not described here in detail), the user applies force to push the docking space 20 of the connector 2 onto the connecting portion 11 of the adapter 1. The connecting portion 11 of the adapter 1 can be pushed into the docking space 20 of the connector 2 through the coupling member 3 outside the connector 2 to abut against the two abutting portions (3111, 3121) of the wrap 31. After the wrap 31 is first pushed open outward by the beveled guide surfaces (3111a, 3121a) of the two abutting portions (3111, 3121), the two abutting portions (3111, 3121) then slide along the outer diameter of the connecting portion 11 and pass over the stopper (12, 42) of the adapter 1 and are positioned at the positioning portion (13, 43) to form a holding and fixing state, thereby forming a quick assembly and good sealing structure between the adapter 1 and the connector 2. When the adapter 1 and the connector 2 need to be disassembled, the user applies force to press the release button 32 at the top side of the wrap 31 downward, thereby pushing open the first flap 311 and the second flap 312 of the wrap 31 and allowing the two abutting portions (3111, 3121) to pass over and detach from the stopper (12, 42) on the outer wall of the connecting portion 11, so that the adapter 1 and the connector 2 form a reverse disengagement state. It also has the advantages of fewer components and easy assembly. The structure proposed in the present invention is applied to the water cooling circulation heat dissipation system of personal computers or computer servers and has excellent practicality. Therefore, a patent application is filed to seek patent protection.

The above is only preferred embodiments of the present invention, and do not limit the patent scope of the present invention. Therefore, all simple modifications and equivalent structural changes made by using the contents of the description and drawings of the present invention should be included in the patent scope of the present invention and should be declared.

In summary, the connector structure for water-cooling device of the present invention can achieve its effect and purpose when used. Therefore, this invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and we will be very grateful.

What is claimed is:

1. A connector structure for water-cooling device, comprising:
an adapter comprising at least two connecting portions;
a connector comprising a connector body, a docking space formed inside said connector body for one said connecting portion of said adapter to pass through, a positioning ring formed outside said connector body and at least one hollow groove formed on said positioning ring; and
a coupling member comprising a wrap and a release button, said wrap being mounted on said positioning ring and forming an elastic clamp, said wrap comprising at least one abutting portion formed on an inner wall thereof and passing through said hollow groove and abutting against the outside of said connecting portion in said docking space to form a fixed state, said release button being installed at a top opening of said wrap and being pushed upward by the elastic clamping force of said wrap, said release button being subject to an external force to move downward to push open said wrap and make said abutting portion disengage from said connecting portion in said docking space, so that said adapter and said connector are in a detachable state.

2. The connector structure for water-cooling device as claimed in claim 1, wherein said connector body of said adapter is in the shape of a cutting cylinder or a tubular body.

3. The connector structure for water-cooling device as claimed in claim 1, wherein said adapter further comprises a stopper formed on an outer wall of each said connecting portion for said abutting portion of said coupling member to pass over, and a positioning portion formed on the said outer wall of each said connecting portion for said abutting portion to be positioned.

4. The connector structure for water-cooling device as claimed in claim 1, wherein said positioning ring of said connector is provided with a flat stop surface on a bottom side thereof corresponding to said release button.

5. The connector structure for water-cooling device as claimed in claim 1, wherein said connector further comprises a core tube mounted in said docking space, and a first spring sleeved on the outside of said core tube, said first spring having two opposite ends respectively abutted against and locked on a water guide near a water outlet of said connector body and a narrow pipe wall of said connector body, said water guide comprising a locking portion with an external thread and an extension portion extending into the water outlet.

6. The connector structure for water-cooling device as claimed in claim 1, wherein said wrap is composed of a first flap and a second flap, said first flap comprising two first coupling portions provided at a bottom side thereof, said second flap comprising a second coupling portion provided at a bottom side thereof and inserted between said two first coupling portions, each of said first coupling portions and said second coupling portion having an axial hole for a pivot to pass through, said pivot having one end thereof inserted and fixed in a shaft groove on an outer wall surface of said connector body of said connector facing said adapter, said first flap and said second flap respectively having a inner wall thereof protrudingly provided with said abutting portion, said abutting portion having the edge formed with a beveled guide surface.

7. The connector structure for water-cooling device as claimed in claim 6, wherein said first flap further comprises two first limiting portions bent inward and a first slide groove formed inside between said two first limiting portions; said second flap further comprises two second limiting portions bent inward and a second slide groove formed inside between said two second limiting portions; said release button further comprises two guide plates converged downward at a bottom side thereof and respectively positioned said first slide groove and said second slide groove to form a vertical movement structure of said release button on said wrap.

8. The connector structure for water-cooling device as claimed in claim 6, wherein said first flap and said second flap have a positioning groove formed on the outside thereof; said coupling member further comprises a U-shaped elastic member combined and positioned in said positioning groove.

9. The connector structure for water-cooling device as claimed in claim 1, wherein said release button comprises a base portion located at a bottom side and a plate-shaped operating portion located at a top side, said base portion comprising said two guide plates, a central protrusion located between said two guide plates, and two limiting grooves formed between said two guide plates and said central protrusion for positioning said two first limiting portions and said two second limiting portions of said wrap.

10. The connector structure for water-cooling device as claimed in claim 9, wherein said central protrusion has two stop blocks formed at a bottom side thereof for stopping said two first limiting portions and said two second limiting portions.
